(19) United States
(12) Patent Application Publication
(10) Pub. No.: US 2014/0252893 A1
(43) Pub. Date: Sep. 11, 2014

(54) ELECTRICAL MACHINE

(71) Applicant: BAUMUELLER NUERNBERG GMBH, Nuernberg (DE)

(72) Inventors: MICHAEL VEEH, KLEINRINDERFELD (DE); BIRGID MEISTER, SULZFELD (DE)

(73) Assignee: BAUMUELLER NUERNBERG GMBH, Nuernberg (DE)

(21) Appl. No.: 14/283,429

(22) Filed: May 21, 2014

Related U.S. Application Data
(63) Continuation of application No. PCT/EP2012/004518, filed on Oct. 29, 2012.

(30) Foreign Application Priority Data
Nov. 21, 2011 (DE) 102011118917.7

(51) Int. Cl. H02K 9/197

(52) U.S. Cl. CPC H02K 9/197
USPC 310/54; 310/58

(57) ABSTRACT

An electrical machine includes a coolable stator having an annular laminated stator core formed of a number of stator laminations having stator teeth which point radially inwards and form stator slots therebetween for accommodating a field winding wound onto the stator teeth. The laminated stator core has peripheral passage openings aligned with one another and forming cooling ducts.

### CROSS-REFERENCE TO RELATED APPLICATION

This is a continuation, under 35 U.S.C. §120, of copending International Application No. PCT/EP2012/004518, filed Oct. 29, 2012, which designated the United States; this application also claims the priority, under 35 U.S.C. §119, of German Patent Application DE 10 2011 118 917.7, filed Nov. 21, 2011; the prior applications are herewith incorporated by reference in their entirety.

### BACKGROUND OF THE INVENTION

1. Field of the Invention

The invention relates to an electrical machine having a rotor and a stator which can be cooled, which coaxially surrounds the rotor and which has an annular laminated stator core with stator teeth which are directed radially inward and between which stator slots are formed for accommodating a field winding which is wound onto the stator teeth. The laminated stator core is formed from a number of stator laminations with passage openings which are formed in the periphery of the stator laminations in a stator yoke region which surrounds the stator teeth and which are aligned with one another in the laminated stator core and form cooling channels. The electrical machine may be a motor or a generator.

German Patent DE 44 11 055 C2 discloses providing a cooling circuit in which a liquid coolant circulates in order to cool a highly dynamic electric motor. The coolant flows into two sleeves which are at least partially spaced apart from one another and surround a stator in an approximately concentric manner. An inner sleeve of the two sleeves bears against the outer face of the stator by way of its entire surface. A stator winding head cooling device is connected to the cooling circuit for the coolant which flows in the sleeves.

German Utility Model DE 20 2005 021 025 U1 discloses a cooled electro dynamic machine having a stator and having a can which bears against an inner wall of the cylindrical stator and seals off slots which are provided in the stator and in which flow channels that run in the slots are formed.

German Patent Application DE 101 03 447 A1, corresponding to U.S. Pat. No. 6,822,352, discloses a stator cooling device of an electrical machine, wherein the stator is formed from an electrical laminated core and has one or more cooling channels for a flowing cooling medium and the cooling channels can be flexibly deformed and act on the laminated core. The cooling channels are formed by flexible corrugated metal tubes.

German Patent Application DE 100 05 128 A1 discloses a stator, which can be cooled, for an electrical machine having a rotating internal rotor, wherein the stator, which can be cooled, has a cross section of rectangular shape with beveled corner regions. Cooling channels with cooling pipes which are inserted therein for conducting a coolant stream are disposed in corner regions, with the cooling channels passing through the stator parallel to a rotation axis.

### SUMMARY OF THE INVENTION

It is accordingly an object of the invention to provide an electrical machine, which overcomes the hereinafore-mentioned disadvantages of the heretofore-known machines of this general type, which has a stator that can be cooled as effectively as possible and which, in particular, may form a cooling space in the region of stator-end winding heads in as optimum a manner as possible.

With the foregoing and other objects in view there is provided, in accordance with the invention, an electrical machine, comprising a rotor and a stator coaxially surrounding the rotor and having an annular laminated stator core and a stator yoke region. The laminated stator core has an end face and radially-inwardly directed stator teeth. The stator teeth form stator slots therebetween and the stator teeth are surrounded by the stator yoke region. The laminated stator core is formed of a number of stator laminations having peripheries with passage openings incorporated therein in the stator yoke region. The passage openings are mutually aligned in the laminated stator core and form cooling channels having end faces and being configured to receive a flow of a cooling medium. A field winding is wound onto the stator teeth and accommodated in the stator slots, the field winding having winding heads projecting out of the end face of the laminated stator core and being contacted by a flow of the cooling medium around the winding heads. A potential compensation cable is provided and at least one hollow screw is inserted into the end face of at least a respective one of the cooling channels functioning to accommodate the at least one respective hollow screw, with the at least one hollow screw securing the potential compensation cable and maintaining functioning of the respective cooling channel to cool the stator.

To this end, the stator includes a laminated, preferably annular, core including stator laminations. Stator slots, which are intended to accommodate coils or coil turns of a field winding (stator winding) which is wound onto the stator teeth, are formed between stator teeth which are directed radially inward. A number of passage openings are made in each stator lamination, with the passage openings being aligned with one another in the laminated stator core and forming cooling channels.

The passage openings or cooling channels are used directly for a cooling medium, in particular oil. The passage openings or cooling channels within the laminated stator core not only provide comparatively good stator cooling, but also provide a comparatively large cooling space in the region of the stator-end winding heads.

The passage openings are disposed in the stator yoke region which surrounds the stator teeth, in particular in the region between two adjacent stator slots. The stator laminations within the laminated core and/or the laminated stator core are/is transposed, offset or rotated, in particular, by a total of one tooth width. Due to the transposition, the cooling channels which are formed by the passage openings run within the laminated stator core or within the yoke region of the laminated stator core in a helical manner.

The electrical machine has a machine housing for accommodating the stator and a rotor. A can for forming a stator-end coolant space (cooling space) for a cooling medium, in particular oil, or for sealing off the rotor from the coolant space is advantageously disposed in an air gap between the rotor and the stator. Cooling medium flows around winding heads of the field winding. The winding heads project out of the end face of the laminated stator core, with the cooling medium flowing through the laminated stator core by way of the cooling channels of the laminated stator core.

The advantages achieved by the invention are, in particular, that effective cooling is achieved and a particularly compact construction of the wound stator is also possible due to the introduction of the cooling openings into the individual stator laminations and the orientation of the cooling openings in alignment with one another within the laminated stator core and also preferably over the circumference of the stator yoke region.

Other features which are considered as characteristic for the invention are set forth in the appended claims.

Although the invention is illustrated and described herein as embodied in an electrical machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a stator, which is constructed as a laminated core, with an annular cross section, stator teeth which project radially inward and stator slots which are provided between the stator teeth;

FIG. 2 is a plan view of a stator lamination of the laminated stator core according to FIG. 1;

FIG. 3 is a perspective view of the stator according to FIG. 1 including winding heads and connection cables for potential compensation; and

FIG. 4 is a longitudinal-sectional view of an electric motor having a stator according to FIG. 3.

### DETAILED DESCRIPTION OF THE INVENTION

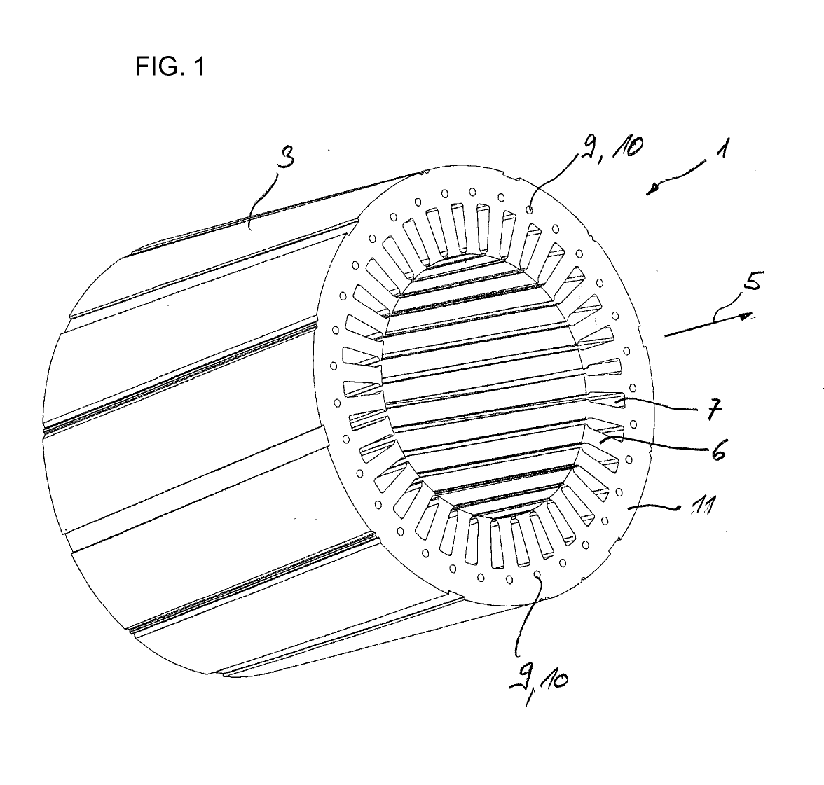

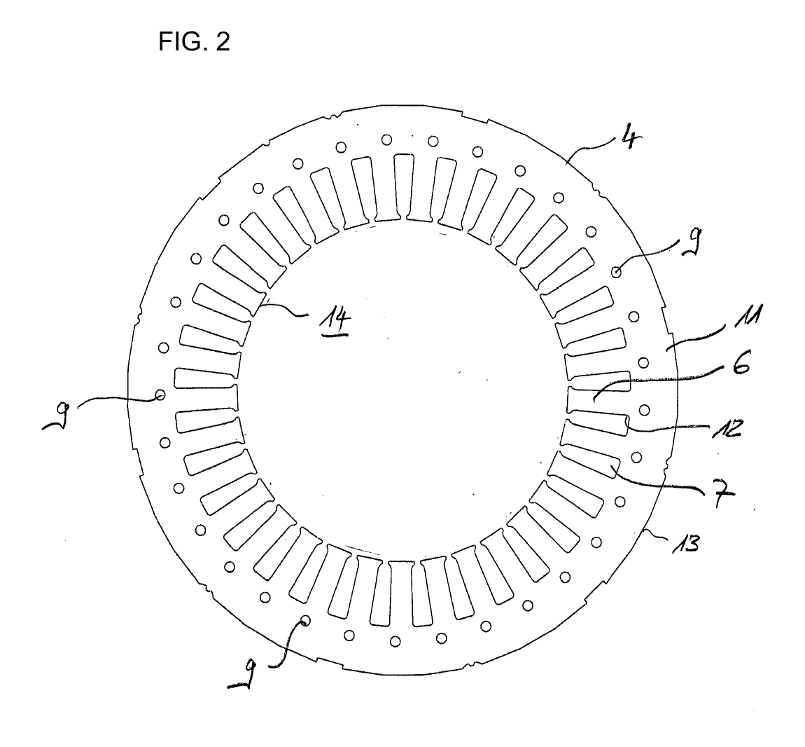

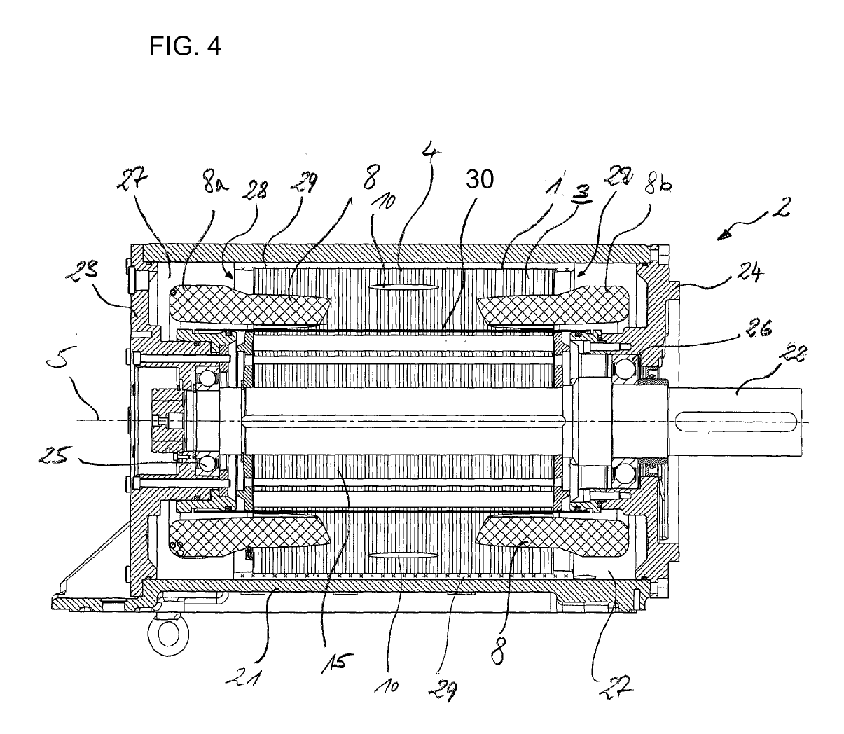

Referring now in detail to the figures of the drawings, in which parts that correspond to one another are provided with the same reference symbols, and first, particularly, to FIG. 1 thereof, there is seen a perspective view of a stator 1 of an electric motor 2 as the electrical machine, which is illustrated in a longitudinal section in FIG. 4. The stator 1 is constructed as a laminated core 3 including a number of annular stator laminations 4 (seen in FIG. 2) which are stacked in the axial direction 5 and connected to one another, for example welded or joined to one another in some other way. In this case, the stator laminations 4 are preferably assembled directly, that is to say without material application, a coating layer or the like.

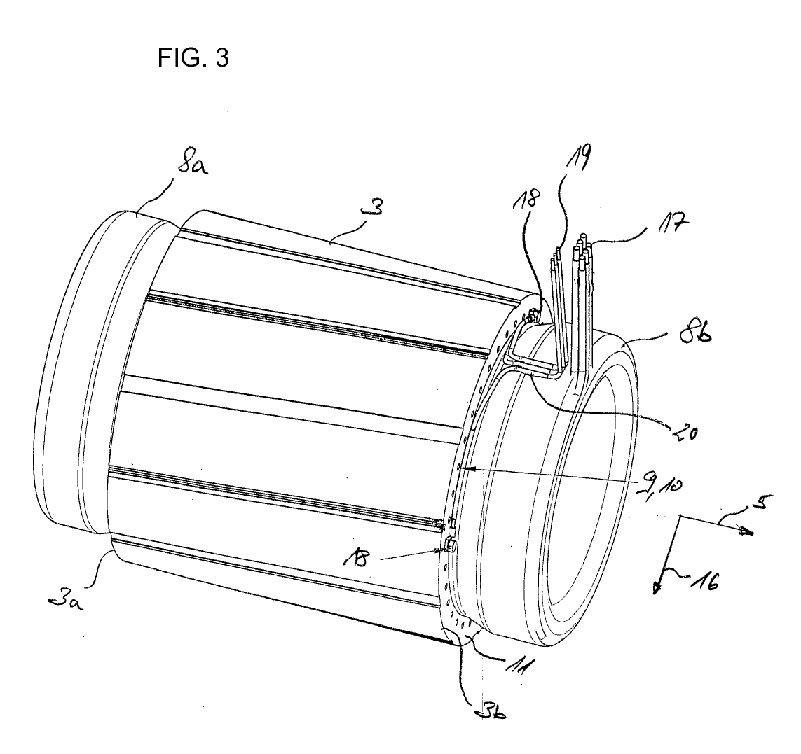

According to FIG. 2, the individual stator laminations 4 have stator teeth 6 which are directed radially inward and between which stator slots 7 are formed. Coils of a field or stator winding 8 (FIGS. 3 and 4) are wound onto the stator teeth 6. The stator slots 7, which are formed between the stator teeth 6, serve to accommodate the coil windings.

A number of passage or cooling channel openings 9 are made in each of the stator laminations 4. The openings 9 are aligned with one another within the laminated stator core 3 where they form cooling channels 10 (FIG. 1). The openings 9 and therefore the cooling channels 10 are suitably disposed in a stator yoke (or stator yoke region) 11 which surrounds the stator teeth 6 and is integral or formed in one-piece with the stator teeth.

The laminated stator core 3 is preferably cylindrical, so that the stator yoke region 11 is in the form of a ring. The passage openings 9 within the individual stator laminations 4 are preferably located between adjacent stator slots 7 and also, with reference to the stator teeth 6, radially between connections 12 of the stator teeth to the stator yoke region 11 and an outer circumference, periphery or outer circumferential edge 13 of the stator yoke region. The free ends of the stator teeth 6 form a so-called pole shoe 14 radially on the inside. The pole shoe delimits an annular air gap (annular gap) between the stator 1 and a rotor 15 of the electric motor 2 (which is illustrated in FIG. 4) at the stator end.

As shown in FIG. 1, the laminated stator core 3 is expediently transposed or offset by a total of one tooth width of a stator tooth 6. To this end, the stator laminations 4 within the laminated stator core 3 are rotated in relation to one another, preferably in the clockwise direction. Therefore, both the stator slots 7 and the stator teeth 6 and, in particular, the cooling channels 10 within the stator yoke region 11, run in a virtually helical manner.

FIG. 3 shows the laminated stator core 3 according to FIG. 1 in the mounted state provided with the field or stator winding 8. During the course of winding onto the stator teeth 6, winding heads 8a and 8b of the field or stator winding 8 are formed at end faces 3a and 3b of the stator core 3, with the winding heads projecting beyond the laminated stator core 3 in the axial direction 5. As can be seen in FIG. 3, the winding heads 8a, 8b extend in the radial direction 16, at the end face 3b of the laminated stator core 3, in such a way that the stator yoke region 11 is accessible, in particular to a cooling medium. As can also be seen, coil or winding ends 17 of the typically three-phase field or stator windings 8 are routed outward at the winding head 8b.

Furthermore, FIG. 3 shows that some of the cooling channels 10 are used, at the mouth end, to accommodate preferably hollow screws as fastening elements 18. The fastening elements fasten cables or lines 19 for potential compensation to the laminated stator core 3 and make contact with them there. Each cable 19 is provided, for example, with a respective protective tube 20. Therefore, three cooling channels 10 from amongst the cooling channels 10 are used for potential compensation. The fastening elements 18, which are preferably constructed as hollow screws, allow the function of the cooling channel 10 to be maintained, with the cooling channel additionally assuming the function of accommodating the fastening element 18 for potential compensation.

The electric motor 2 (illustrated in a longitudinal section in FIG. 4) has a motor housing 21 in which the stator 1 and the rotor 15 are disposed. The rotor 15 sits on a motor shaft 22. The motor shaft is mounted within the motor housing 21, preferably by using rolling or ball bearings 25 or 26, in the region of end plates 23, 24 which are connected to an end face of the motor housing 21, and the motor shaft is routed out of the motor housing 21 at one end.

A cylindrical, closed can 30 is disposed in the air gap which remains between the stator 1 and the rotor 15. The can 30 delimits a stator-end cooling space 27 for a cooling medium, in particular oil. Cooling medium flows around the winding heads 8a, 8b of the field winding 8. The winding heads 8a, 8b project out of the end face of the laminated stator core 3 and the cooling medium additionally flows through the cooling channels 10 which are formed by the passage openings 9 in the stator laminations 4.

It can be seen that the stator yoke region 11 is accessible and therefore serves as an abutment face 28 against which an apparatus, for example in the form of a cylindrical mold or the like, can bear. The apparatus or mold serves to introduce or apply an insulating medium, for example wax or the like, in or into the winding heads 8a, 8b. Further insulating material 29 is also introduced into the motor housing 21 between the stator 1 or the laminated stator core 3 of the stator and the inner wall of the motor housing.

The invention is not restricted to the exemplary embodiment described above. Rather, other variants of the invention can also be derived from the exemplary embodiment by a person skilled in the art, without departing from the subject matter of the invention. In particular, all of the individual features which are described in connection with the exemplary embodiment can further be combined with one another in another way, without departing from the subject matter of the invention.

1. An electrical machine, comprising:
a rotor;
a stator coaxially surrounding said rotor and having an annular laminated stator core and a stator yoke region;
said laminated stator core having an end face and radially-inwardly directed stator teeth, said stator teeth forming stator slots therebetween and said stator teeth being surrounded by said stator yoke region;
said laminated stator core being formed of a number of stator laminations having peripheries with passage openings incorporated therein in said stator yoke region, said passage openings being mutually aligned in said laminated stator core and forming cooling channels having end faces and being configured to receive a flow of a cooling medium;
a field winding wound onto said stator teeth and accommodated in said stator slots, said field winding having winding heads projecting out of said end face of said laminated stator core and being contacted by a flow of the cooling medium around said winding heads;
a potential compensation cable; and
at least one hollow screw inserted into said end face of at least a respective one of said cooling channels functioning to accommodate said at least one respective hollow screw, said at least one hollow screw securing said potential compensation cable and maintaining functioning of said respective cooling channel to cool said stator.

2. The electrical machine according to claim 1, wherein said passage openings are each provided in a region between a respective adjacent two of said stator slots.

3. The electrical machine according to claim 1, wherein said laminated stator core is transposed.

4. The electrical machine according to claim 3, wherein said laminated stator core is transposed by a total of one tooth width of one of said stator teeth.

5. The electrical machine according to claim 1, which further comprises a can disposed in an air gap formed between said rotor and said stator and forming a stator-end coolant space for the cooling medium.

6. The electrical machine according to claim 5, wherein the cooling medium is oil.

7. The electrical machine according to claim 5, wherein said can is configured and constructed to seal off said rotor from said coolant space.
